(19) United States
(12) Patent Application Publication
(10) Pub. No.: US 2021/0087417 A1
(43) Pub. Date: Mar. 25, 2021

(54) INK, IMAGE FORMING METHOD, AND IMAGE FORMING APPARATUS

(71) Applicants: Satoshi TAKAHASHI, Kanagawa (JP); Takahiro WATANABE, Kanagawa (JP)

(72) Inventors: Satoshi TAKAHASHI, Kanagawa (JP); Takahiro WATANABE, Kanagawa (JP)

(21) Appl. No.: 17/021,388

(22) Filed: Sep. 15, 2020

(30) Foreign Application Priority Data
Sep. 19, 2019 (JP) 2019-170192

(51) Int. Cl. C09D 11/36; C09D 11/033; B41J 2/045; B41M 5/00

(52) U.S. Cl. CPC C09D 11/36; C09D 11/033; B41J 2/04586; B41M 5/0023; B41J 2/04573

(57) ABSTRACT

An ink contains an organic solvent and a coloring material, wherein the ink has a droplet breakage time of 17.0 msec or less according to elongation viscosity measuring.

### CROSS-REFERENCE TO RELATED APPLICATIONS

This patent application is based on and claims priority pursuant to 35 U.S.C. § 119 to Japanese Patent Application No. 2019-170192, filed on Sep. 19, 2019 in the Japan Patent Office, the entire disclosure of which is hereby incorporated by reference herein.

### BACKGROUND

### Technical Field

The present disclosure relates to an ink, an image forming method, and an image forming apparatus.

### Description of the Related Art

Inkjet recording produces text and images on recording media by directly discharging ink droplets from extremely fine nozzles to attach the ink droplets to the recording media. Image forming utilizing inkjet recording is widely used in industrial settings. With the development of inkjet recording technologies, printing performance has been improved. Such high performance requires ink having an excellent drying property and fixability to produce text and images having high image quality.

### SUMMARY

According to embodiments of the present disclosure, an ink is provided which contains an organic solvent and a coloring material, wherein the ink has a droplet breakage time of 17.0 msec or less according to elongation viscosity measuring.

### BRIEF DESCRIPTION OF THE SEVERAL VIEWS OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic diagram illustrating an image forming apparatus using continuous paper according to an embodiment of the present invention;

FIG. 2 is a series of photos showing behaviors of an ink droplet in measuring elongation viscosity; and

FIG. 3 is a graph illustrating a spectrum obtained based on measuring of an attached film of ink containing urethane resin particles and acrylic resin particles by a Fourier transform infrared spectrometer.

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

### DESCRIPTION OF THE EMBODIMENTS

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

As used herein, the singular forms “a”, “an”, and “the” are intended to include the plural forms as well, unless the context clearly indicates otherwise.

Moreover, image forming, recording, printing, modeling, etc., in the present disclosure represent the same meaning, unless otherwise specified.

Embodiments of the present invention are described in detail below with reference to accompanying drawing(s). In describing embodiments illustrated in the drawing(s), specific terminology is employed for the sake of clarity. However, the disclosure of this patent specification is not intended to be limited to the specific terminology so selected, and it is to be understood that each specific element includes all technical equivalents that have a similar function, operate in a similar manner, and achieve a similar result.

For the sake of simplicity, the same reference number will be given to identical constituent elements such as parts and materials having the same functions and redundant descriptions thereof omitted unless otherwise stated.

When ink discharged from a recording head causes ink mist or satellites (droplets separated from the main droplets after being discharged), text quality and image quality readily deteriorate. This deterioration is significant in high performance printing in particular.

JP-2005-349749-A1 has attempted to reduce deterioration of image quality by disposing a wind blowing mechanism that generates and sends wind to the face surface of the recording head and the platen to move satellites and ink mist outside the recording region.

According to the present disclosure, an inkjet ink is provided which has excellent discharging stability and with which high quality images can be produced.

Ink The ink of the present disclosure contains a coloring material and an organic solvent, preferably containing a resin, a lubricant, and water, and other optional components.

Coloring Material

The coloring material has no particular limitation and includes materials such as a pigment and a dye.

The pigment includes an inorganic pigment or an organic pigment. These can be used alone or in combination. In addition, a mixed crystal can also be used as the coloring material.

Examples of the pigments include, but are not limited to, black pigments, yellow pigments, magenta pigments, cyan pigments, white pigments, green pigments, orange pigments, and gloss or metallic pigments of gold, silver, and others.

Carbon black manufactured by known methods such as contact methods, furnace methods, and thermal methods can be used as the inorganic pigment in addition to titanium oxide, iron oxide, calcium carbonate, barium sulfate, aluminum hydroxide, barium yellow, cadmium red, and chrome yellow.

Specific examples of the organic pigment include, but are not limited to, azo pigments, polycyclic pigments (e.g., phthalocyanine pigments, perylene pigments, perinone pigments, anthraquinone pigments, quinacridone pigments, dioxazine pigments, indigo pigments, thioindigo pigments, isoindolinone pigments, and quinophthalone pigments), dye chelates (e.g., basic dye type chelates and acid dye type chelates), nitro pigments, nitroso pigments, and aniline black. Of those pigments, pigments having good affinity with solvents are preferable. Also, hollow resin particles and hollow inorganic particles can be used.

Specific examples of the pigments for black include, but are not limited to, carbon black (C.I. Pigment Black 7) such as furnace black, lamp black, acetylene black, and channel black, metals such as copper, iron (C.I. Pigment Black 11), and titanium oxide, and organic pigments such as aniline black (C.I. Pigment Black 1).

Specific examples of the pigments for color include, but are not limited to, C.I. Pigment Yellow 1, 3, 12, 13, 14, 17, 24, 34, 35, 37, 42 (yellow iron oxide), 53, 55, 74, 81, 83, 95, 97, 98, 100, 101, 104, 108, 109, 110, 117, 120, 138, 150, 153, 155, 180, 185, and 213; C.I. Pigment Orange 5, 13, 16, 17, 36, 43, and 51, C.I. Pigment Red 1, 2, 3, 5, 17, 22, 23, 31, 38, 48:2, 48:2 {Permanent Red 2B(Ca)}, 48:3, 48:4, 49:1, 52:2, 53:1, 57:1 (Brilliant Carmine 6B), 60:1, 63:1, 63:2, 64:1, 81, 83, 88, 101 (rouge), 104, 105, 106, 108 (Cadmium Red), 112, 114, 122 (Quinacridone Magenta), 123, 146, 149, 166, 168, 170, 172, 177, 178, 179, 184, 185, 190, 193, 202, 207, 208, 209, 213, 219, 224, 254, and 264; C.I. Pigment Violet 1 (Rhodamine Lake), 3, 5:1, 16, 19, 23, and 38; C.I. Pigment Blue 1, 2, 15 (Phthalocyanine Blue), 15:1, 15:2, 15:3, 15:4, (Phthalocyanine Blue), 16, 17:1, 56, 60, and 63, C.I. Pigment Green 1, 4, 7, 8, 10, 17, 18, and 36.

The dye is not particularly limited and includes, for example, acidic dyes, direct dyes, reactive dyes, basic dyes. These can be used alone or in combination.

Specific examples of the dye include, but are not limited to, C.I. Acid Yellow 17, 23, 42, 44, 79, and 142, C.I. Acid Red 52, 80, 82, 249, 254, and 289, C.I. Acid Blue 9, 45, and 249, C.I. Acid Black 1, 2, 24, and 94, C. I. Food Black 1 and 2, C.I. Direct Yellow 1, 12, 24, 33, 50, 55, 58, 86, 132, 142, 144, and 173, C.I. Direct Red 1, 4, 9, 80, 81, 225, and 227, C.I. Direct Blue 1, 2, 15, 71, 86, 87, 98, 165, 199, and 202, C.I. Direct Black 19, 38, 51, 71, 154, 168, 171, and 195, C.I. Reactive Red 14, 32, 55, 79, and 249, and C.I. Reactive Black 3, 4, and 35. The proportion of the coloring material in the ink is preferably from 0.1 to 15 percent by mass and more preferably from 1 to 10 percent by mass in terms of enhancement of image density, fixability, and discharging stability.

The ink is obtained by introducing a hydrophilic functional group into a pigment to prepare a self-dispersible pigment, coating the surface of a pigment with a resin followed by dispersion, or using a dispersant to disperse a pigment.

One way to prepare a self-dispersible pigment by introducing a hydrophilic functional group into a pigment is to add a functional group such as a sulfone group and carboxyl group to a pigment (e.g., carbon) to disperse the pigment in water.

One way to disperse a resin by coating the surface thereof is to encapsulate a pigment in a microcapsule to make it disperse in water. This can be referred to as a resin-coated pigment. In this case, all the pigments to be added to ink are not necessarily entirely coated with a resin. Pigments partially or wholly uncovered with a resin are allowed to be dispersed in the ink unless such pigments have an adverse impact.

When a dispersant is used, a known dispersant having a small or large molecular weight represented by a surfactant is used.

It is possible to select an anionic surfactant, a cationic surfactant, a nonionic surfactant, an amphoteric surfactant, or others depending on a pigment.

Also, a nonionic surfactant (RT-100, manufactured by TAKEMOTO OIL & FAT CO., LTD.) and a formalin condensate of naphthalene sodium sulfonate are suitable as the dispersant.

Those can be used alone or in combination.

Pigment Dispersion

The ink can be obtained by mixing a pigment with materials such as water and an organic solvent. It is also possible to mix a pigment with water, a dispersant, and other substances to prepare a pigment dispersion and thereafter mix the pigment dispersion with materials such as water and an organic solvent to manufacture an ink.

The pigment dispersion is obtained by mixing and dispersing water, a pigment, a pigment dispersant, and other optional components and controlling the particle size. It is good to use a dispersing device for dispersion.

The particle diameter of the pigment in the pigment dispersion has no particular limit. For example, the maximum frequency is preferably from 20 to 500 nm and more preferably from 20 to 150 nm in the maximum number conversion to improve dispersion stability of the pigment and ameliorate discharging stability and the image quality such as image density. The particle diameter of the pigment can be analyzed using a particle size analyzer (Nanotrac Wave-UT151, manufactured by MicrotracBEL Corp).

In addition, the proportion of the pigment in the pigment dispersion is not particularly limited and can be suitably selected to suit a particular application. In terms of improving discharging stability and image density, the proportion is preferably from 0.1 to 50 percent by mass and more preferably from 0.1 to 30 percent by mass.

It is preferable that the pigment dispersion be filtered with an instrument such as filter and a centrifuge to remove coarse particles followed by deaerateing.

Organic Solvent

There is no specific limitation to the organic solvent for use in the present disclosure. For example, a water-soluble organic solvent can be used. Examples include, but are not limited to, polyhydric alcohols, ethers such as polyhydric alcohol alkylethers and polyhydric alcohol arylethers, nitrogen-containing heterocyclic compounds, amides, amines, and sulfur-containing compounds.

Specific examples of the water-soluble organic solvent include, but are not limited to, polyols such as ethylene glycol, diethylene glycol, 1,2-propanediol, 1,3-propanediol, 1,2-butanediol, 1,3-butanediol, 1,4-butanediol, 2,3-butanediol, 3-methyl-1,3-butane diol, triethylene glycol, polyethylene glycol, polypropylene glycol, 1,2-pentanediol, 1,3-pentanediol, 1,4-pentanediol, 2,4-pentanediol, 1,5-pentanediol, 1,2-hexanediol, 1,6-hexanediol, 1,3-hexanediol, 2,5-hexanediol, 1,5-hexanediol, glycerin, 1,2,6-hexanetriol, 2-ethyl-1,3-hexanediol, ethyl-1,2,4-butane triol, 1,2,3-butanetriol, 2,2,4-trim ethyl-1,3-pentanediol, and petriol; polyol alkylethers such as ethylene glycol monoethylether, ethylene glycol monobutyl ether, diethylene glycol monomethylether, diethylene glycol monoethylether, diethylene glycol monobutyl ether, tetraethylene glycol monomethylether, and propylene glycol monoethylether; polyol arylethers such as ethylene glycol monophenylether and ethylene glycol monobenzylether; nitrogen-containing heterocyclic compounds such as 2-pyrrolidone, N-methyl-2-pyrrolidone, N-hydroxyethyl-2-pyrrolidone, 1,3-dimethyl-2-imidazolidinone, ε-caprolactam, and γ-butyrolactone; amides such as formamide, N-methylformamide, N,N-dimethylformamide, 3-methoxy-N,N-dimethyl propioneamide, and 3-buthoxy-N,N-dimethyl propioneamide; amines such as monoethanolamine, diethanolamine, and triethylamine; sulfur-containing compounds such as dimethyl sulfoxide, sulfolane, and thiodiethanol; propylene carbonate, and ethylene carbonate.

It is preferable to use an organic solvent having a boiling point of 250 or lower degrees C., which serves as a humectant and imparts a good drying property at the same time.

Polyol compounds having eight or more carbon atoms and glycol ether compounds are also suitable. Specific examples of the polyol compounds having eight or more carbon atoms include, but are not limited to, 2-ethyl-1,3-hexanediol and 2,2,4-trimethyl-1,3-pentanediol.

Specific examples of the glycolether compounds include, but are not limited to, polyhydric alcohol alkylethers such as ethylene glycol monoethylether, ethylene glycol monobutylether, diethylene glycol monomethylether, diethylene glycol monoethylether, diethylene glycol monobutylether, tetraethylene glycol monomethylether, and propylene glycol monoethylether and polyhydric alcohol arylethers such as ethylene glycol monophenylether and ethylene glycol monobenzylether.

It is preferable to contain an amide solvent, 3-ethyl-3-hydroxymethyl oxetane, and propylene glycol monomethyl ether as the organic solvent When a resin is used.

Specific examples of the amide solvent include, but are not limited to, 3-methoxy-N,N-dimethyl propionamide, 3-ethoxy-N,N-dimethyl propionamide, and 3-buthoxy-N,N-dimethyl propionamide.

These can be used alone or in combination. Of these, 3-methoxy-N,N-dimethyl propionamide and 3-buthoxy-N,N-dimethyl propionamide are more preferable to enhance film-forming property of a resin and improve abrasion resistance.

The boiling point of the organic solvent is preferably from 180 to 300 degrees C. When the boiling point of the organic solvent is 180 degrees C. or higher, the evaporation speed of the organic solvent during drying can be suitably controlled. Also, the ink has a leveling property enough to reduce the roughness of the surface of an image such that glossiness is enhanced. An organic solvent having a boiling point of 300 degrees C. or lower enhances the drying property of the ink.

The proportion of the organic solvent in the ink has no particular limit and can be suitably selected to suit to a particular application.

In terms of drying and discharging reliability of the ink, the proportion is preferably from 10 to 60 percent by mass and more preferably from 20 to 60 percent by mass.

The proportion of the amide solvent in the ink is preferably from 0.05 to 10 percent by mass and more preferably from 0.1 to 5 percent by mass.

Diethylene glycol and/or triethylene glycol is preferably included in the ink to enhance discharging stability for continuous image forming and obtain an ink having a high vapor pressure and good drying property at high temperatures.

The proportion of diethylene glycol and/or triethylene glycol in the ink is more preferably from 1 to 10 percent by mass and more preferably from 3 to 6 percent by mass. When the proportion is 1 percent by mass or more, discharging stability is further improved. When the proportion is 10 percent by mass or less, the amount of the organic solvent present on the image portion on a recording medium is small enough to minimize plasticizing resins so that fixability can be maintained and image transfer to a heated roller can be thus prevented.

Resin

The type of the resin contained in the ink has no particular limit and can be suitably selected to suit to a particular application. Examples include, but are not limited to, urethane resins, polyester resins, acrylic-based resins, vinyl acetate-based resins, styrene-based resins, butadiene-based resins, styrene-butadiene-based resins, vinylchloride-based resins, acrylic styrene-based resins, and acrylic silicone-based resins.

Resin particles made of such resins can be also used. It is possible to mix a resin emulsion in which such resin particles are dispersed in water as a dispersion medium with materials such as a coloring material and an organic solvent to obtain an ink. The resin particle can be synthesized or procured and used alone or in combination.

Urethane Resin Particle

Of these resin particles, it is preferable to use urethane resin particles in combination with other resin particles because the urethane resin particles have a high tack, which reduces blocking resistance.

Due to this high tack, however, robust images are formed, which enhances fixability.

Furthermore, urethane resin particles having a glass transition temperature (Tg) of from −20 to 70 degrees C. have excellent tack when images are formed with the ink so that fixability is further enhanced.

Examples of the urethane resin particle include, but are not limited to, polycarbonate urethane resin particles, polyester urethane resin particles, and polyether urethane resin particles. These can be used alone or in combination. Of these, polycarbonate urethane resin particles are preferable in terms of abrasion resistance.

The polycarbonate urethane resin particle has a polycarbonate backbone and includes polycarbonate-based urethane resin particle.

The glass transition temperature (Tg) of the urethane resin particle is preferably from −20 to 70 degrees C. When the glass transition temperature (Tg) of the urethane resin particle is from −20 to 70 degrees C., tackiness is strong so that film-forming property is good. For this reason, good abrasion resistance is achieved.

Acrylic Resin Particle

Moreover, of the resin particles mentioned above, acrylic resin particles are widely used because they are inexpensive and have good discharging stability.

However, because acrylic resin particles have low abrasion resistance, and hence are used together with elastic urethane resin particles in one example.

Examples of the acrylic resin particles include, but are not limited to, acrylic silicone resin particles and styrene-acrylic resin particles. These can be used alone or in combination. Of these, acrylic-silicone resin particles are preferable in terms of abrasion resistance.

Styrene acrylic resin particles can be formed by emulsion polymerization, dispersion polymerization, suspension polymerization, pulverization or solution/bulk polymerization followed by emulsification.

Styrene acrylic resin particles can be procured.

Specific examples of procured styrene acrylic resin particles include, but are not limited to, J-325, J-390, J-450, J-511, J-734, J-741, J-775, J-840, J-7100, J-7300, HPD-71, HRC-1645, JDX-5050, PDX-6102B (all manufactured by BASF SE), and UC-3900 (manufactured by TOAGOSEI CO., LTD.).

The mass ratio (percent by mass) of the urethane resin particle to the acrylic resin particle is preferably from 0.03 to 0.7 and more preferably from 0.23 to 0.46.

When an ink film formed with an ink having a mass ratio (urethane resin particle/acrylic resin particle) of from 0.03 to 0.7 is measured by Fourier Transform Infrared Spectroscopy (FT-IR), it is preferable to have the following properties.

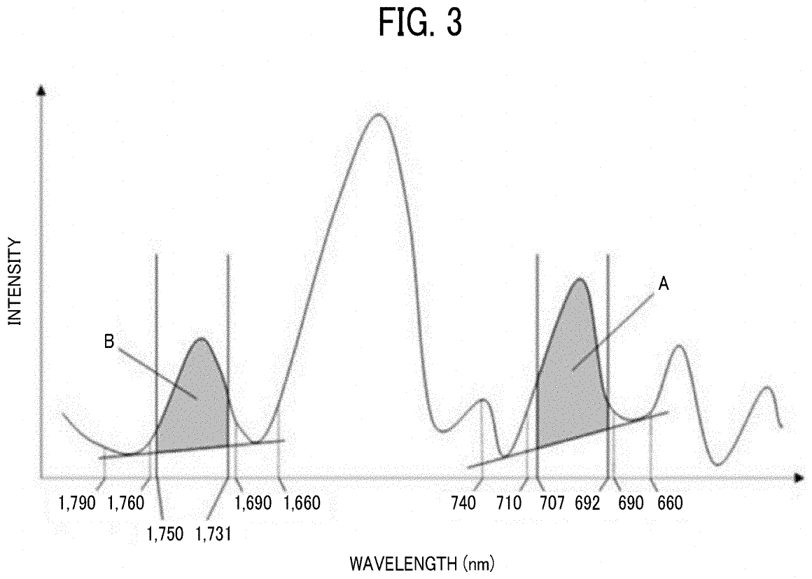

As illustrated in FIG. 3, an area A represents a peak region enclosed by a region of the spectrum between 692 cm⁻¹ and 707 cm⁻¹ and a tangent linking the minimum point between 710 cm⁻¹ and 740 cm⁻¹ and the minimum point between 660 cm⁻¹ and 690 cm⁻¹. As illustrated in FIG. 3, an area B represents a peak region enclosed by a region of the spectrum between 1,731 cm⁻¹ and 1,750 cm⁻¹ and a tangent linking the minimum point between 1,660 cm⁻¹ and 1,690 cm⁻¹ and the minimum point between 1,760 cm⁻¹ and 1,790 cm⁻¹.

The area ratio (B/A) of each peak region is preferably from 0.3 to 1.0, more preferably from 0.51 to 1.0, and particularly preferably from 0.6 to 1.0. When the area ratio (B/A) is from 0.3 to 1.0, there is no trade-off between improvement of abrasion resistance by urethane resin particles and improvement of blocking resistance by acrylic resin particles.

For FT-IR for the ink film, attenated total reflection (ATR) of Fourier Transform infrared spectrophotometer can be utilized.

The area A and the area B can be calculated based on the spectrum of the surface of an image formed on paper (Lumi Art Gloss, 130 gsm, manufactured by Stora Enso AB) with ink in an amount of 1.12 mg/cm² (700 mg/A4) obtained according to ATR by diamond indenter using Spectrum One (manufactured by PerkinElmer Japan Co., Ltd.).

The mean volume diameter (i.e., volume average particle diameter) of the resin particle is not particularly limited and can be suitably selected to suit to a particular application. The mean volume diameter is preferably from 10 to 1,000 nm, more preferably from 10 to 200 nm, and particularly preferably from 10 to 100 nm to achieve good fixability and image robustness.

The volume average particle diameter can be measured by using, for example, a particle size analyzer (Nanotrac Wave-UT151, manufactured by MicrotracBEL Corp.).

The proportion of the resin in the ink is not particularly limited and can be suitably selected to suit to a particular application. In terms of fixability and storage stability of the ink, it is preferably from 1 to 30 percent by mass and more preferably from 5 to 20 percent by mass of the total amount of the ink.

Lubricant

The ink preferably contains a lubricant. Inclusion of a lubricant in the ink enhances abrasion resistance. Glossiness can be enhanced by a combinational use of a lubricant and a resin.

There is no specific limit to the lubricant and it can be suitably selected to suit to a particular application. For example, wax is usable. An example of the wax is polyethylene wax.

Polyethylene wax can be procured.

There is no specific limitation on procurable polyethylene wax and it can be suitably selected to suit to a particular application.

Specific examples include, but are not limited to, Aquapetro DP2502C and Aquapetro DP2401 (both manufactured by TOYO ADL CORPORATION). These can be used alone or in combination.

The proportion of the lubricant is preferably from 0.05 to 2 percent by mass, more preferably from 0.05 to 0.5 percent by mass, and furthermore preferably from 0.05 to 0.45 percent by mass, and particularly preferably from 0.15 to 0.45 percent by mass to the total content of ink. When the proportion of the lubricant is from 0.05 to 2 percent by mass, abrasion resistance and glossiness can be enhanced. When the proportion is from 0.05 to 0.45 percent by mass, it is possible to ameliorate storage stability and discharging stability of the ink.

The particle diameter of the solid portion in the ink has no particular limit and can be suitably selected to suit to a particular application. For example, the maximum frequency in the maximum number conversion is preferably from 20 to 1,000 nm and more preferably from 20 to 150 nm to ameliorate the discharging stability and image quality such as image density. The solid portion includes particles such as resin particles and pigment particles. The particle diameter can be measured by using a particle size analyzer (Nanotrac Wave-UT151, manufactured by MicrotracBEL Corp).

Water

The proportion of water of the ink is not particularly limited and can be suitably selected to suit to a particular application. For example, in terms of enhancing the drying and discharging reliability of the ink, the proportion is preferably from 10 to 90 percent by mass and more preferably from 20 to 60 percent by mass.

There is no specific limitation to the water and it can be suitably selected to suit to a particular application. For example, pure water and ultra pure water such as purified water, deionized water, ultrafiltered water, reverse osmosis water, and distilled water are suitable. These can be used alone or in combination.

Additive

Additives such as a surfactant, a defoaming agent, preservative and fungicide, corrosion inhibitor, and pH regulator can be added to the ink.

Surfactant

Examples of the surfactant include, but are not limited to, silicone-based surfactants, fluorochemical surfactants, amphoteric surfactants, nonionic surfactants, and anionic surfactants.

The silicone-based surfactant has no specific limit and can be suitably selected to suit to a particular application. Of these, surfactants not decomposable in a high pH environment are preferable. Examples of the silicone-based surfactants include, but are not limited to, side chain modified polydimethyl siloxane, both terminal-modified polydimethyl siloxane, one-terminal-modified polydimethyl siloxane, and side-chain-both-terminal-modified polydimethyl siloxane. In particular, silicone-based surfactants having a polyoxyethylene group or a polyoxyethylene polyoxypropylene group as a modification group are particularly preferable because such an aqueous surfactant demonstrates good properties. It is possible to use a polyether-modified silicone-based surfactant as the silicone-based surfactant. A specific example is a compound in which a polyalkylene oxide structure is introduced into the side chain of the Si site of dimethyl silooxane.

Specific examples of the fluorochemical surfactant include, but are not limited to, perfluoroalkyl sulfonic acid compounds, perfluoroalkyl carboxylic acid compounds, ester compounds of perfluoroalkyl phosphoric acid, adducts of perfluoroalkyl ethylene oxide, and polyoxyalkylene ether polymer compounds having a perfluoroalkyl ether group in its side chain. These are particularly preferable because the fluorochemical surfactant does not readily produce foams.

Specific examples of the perfluoroalkyl sulfonic acid compounds include, but are not limited to, perfluoroalkyl sulfonic acid and salts of perfluoroalkyl sulfonic acid.

Specific examples of the perfluoroalkyl carbonic acid compounds include, but are not limited to, perfluoroalkyl carbonic acid and salts of perfluoroalkyl carbonic acid. Specific examples of the polyoxyalkylene ether polymer compounds having a perfluoroalkyl ether group in its side chain include, but are not limited to, sulfuric acid ester salts of polyoxyalkylene ether polymer having a perfluoroalkyl ether group in its side chain, and salts of polyoxyalkylene ether polymers having a perfluoroalkyl ether group in its side chain. Counter ions of salts in these fluorochemical surfactants are, for example, Li, Na, K, NH₄, NH₃CH₂CH₂OH, NH₂(CH₂CH₂OH)₂, and NH(CH₂CH₂OH)₃.

Specific examples of the ampholytic surfactants include, but are not limited to, lauryl aminopropionic acid salts, lauryl dimethyl betaine, stearyl dimethyl betaine, and lauryl dihydroxyethyl betaine.

Specific examples of the nonionic surfactants include, but are not limited to, polyoxyethylene alkyl phenyl ethers, polyoxyethylene alkyl esters, polyoxyethylene alkyl amines, polyoxyethylene alkyl amides, polyoxyethylene propylene block polymers, sorbitan aliphatic acid esters, polyoxyethylene sorbitan aliphatic acid esters, and adducts of acetylene alcohol with ethylene oxides.

Specific examples of the anionic surfactants include, but are not limited to, polyoxyethylene alkyl ether acetates, dodecyl benzene sulfonates, laurates, and polyoxyethylene alkyl ether sulfates.

These can be used alone or in combination.

The silicone-based surfactant has no particular limit and can be suitably selected to suit to a particular application.

Specific examples include, but are not limited to, side-chain-modified polydimethyl siloxane, both distal-end-modified polydimethyl siloxane, one-distal-end-modified polydimethyl siloxane, and side-chain-both-distal-end-modified polydimethyl siloxane. In particular, a polyether-modified silicone-based surfactant having a polyoxyethylene group or a polyoxyethylene polyoxypropylene group is particularly preferable because such a surfactant demonstrates good property as an aqueous surfactant.

Any suitable synthetic surfactant and any product available on the market is suitable. Products are available from BYK-Chemie GmbH, Shin-Etsu Silicone Co., Ltd., Dow Corning Toray Co., Ltd., NIHON EMULSION Co., Ltd., Kyoeisha Chemical Co., Ltd., and others.

The polyether-modified silicon-based surfactant has no particular limit and can be suitably selected to suit to a particular application. For example, a compound is usable in which the polyalkylene oxide structure represented by the following Chemical formula S-1 is introduced into the side chain of the Si site of dimethyl polysiloxane.

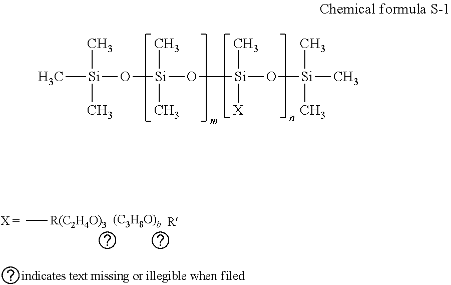

In Chemical formula S-1, “m”, “n”, “a”, and “b” each, respectively independently represent integers, R represents an alkylene group, and R′ represents an alkyl group.

Specific examples of the polyether-modified silicone-based surfactant include, but are not limited to, KF-618, KF-642, and KF-643 (all manufactured by Shin-Etsu Chemical Co., Ltd.), EMALEX-SS-5602 and SS-1906EX (both manufactured by NIHON EMULSION Co., Ltd.), FZ-2105, FZ-2118, FZ-2154, FZ-2161, FZ-2162, FZ-2163, and FZ-2164 (all manufactured by Dow Corning Toray Co., Ltd.), BYK-33 and BYK-387 (both manufactured by BYK Chemie GmbH), and TSF4440, TSF4452, and TSF4453 (all manufactured by Momentive Performance Materials Inc.).

A fluorochemical surfactant in which the number of carbon atoms replaced with fluorine atoms is 2 to 16 is preferable and, 4 to 16, more preferable.

Specific examples of the fluorochemical surfactant include, but are not limited to, perfluoroalkyl phosphoric acid ester compounds, adducts of perfluoroalkyl with ethylene oxide, and polyoxyalkylene ether polymer compounds having a perfluoroalkyl ether group in its side chain. Of these, polyoxyalkylene ether polymer compounds having a perfluoroalkyl ether group in the side chain thereof are preferable because these polymer compounds do not easily foam and the fluorosurfactant represented by the following Chemical formula F-1 or Chemical formula F-2 is more preferable.

CF₃CF₂(CF₂F₂)ₘ—CH₂CH₂O(CH₂CH₂O)ₙH Chemical formula F-1

In the Chemical Formula F-1, “m” is preferably 0 or an integer of from 1 to 10 and “n” is preferably 0 or an integer of from 1 to 40.

CₙF₂ₙ₊₁—CH₂CH(OH)CH₂—O—(CH₂CH₂O)ₙ—Y Chemical Formula F-2

In the compound represented by the chemical formula F-2, Y represents H or CₘF₂ₘ₊₁, where n represents an integer of from 1 to 6, or CH₂CH(OH)CH₂—CₘF₂₊₁, where m represents an integer of from 4 to 6, or CₚH₂ₚ₊₁, where p is an integer of from 1 to 19. “n” represents an integer of from 1 to 6. “a” represents an integer of from 4 to 14.

The fluorochemical surfactant is commercially available. Specific examples include, but are not limited to, SURFLON S-111, S-112, S-113, S-121, S-131, S-132, S-141, and S-145 (all manufactured by ASAHI GLASS CO., LTD.); FLUORAD FC-93, FC-95, FC-98, FC-129, FC-135, FC-170C, FC-430, and FC-431 (all manufactured by SUMITOMO 3M); MEGAFACE F-470, F-1405, and F-474 (all manufactured by DIC CORPORATION); ZONYL TBS, FSP, FSA, FSN-100, FSN, FSO-100, FSO, FS-300, UR, and Capstone™ FS-30, FS-31, FS-3100, FS-34, and FS-35 (all manufactured by The Chemours Company); FT-110, FT-250, FT-251, FT-400S, FT-150, and FT-400SW (all manufactured by NEOS COMPANY LIMITED); POLYFOX PF-136A, PF-156A, PF-151N, PF-154, and PF-159 (manufactured by OMNOVA SOLUTIONS INC.); and UNIDYNE™ DSN-403N (manufactured by DAIKIN INDUSTRIES, Ltd.). Of these, in terms of improvement on print quality, in particular coloring property and permeability, wettability, and uniform dying property on paper, FS-3100, FS-34, and FS-300 of The Chemours Company, FT-110, FT-250, FT-251, FT-400S, FT-150, and FT-400SW of NEOS COMPANY LIMITED, POLYFOX PF-151N of OMNOVA SOLUTIONS INC., and UNIDYNE™ DSN-403N (manufactured by DAIKIN INDUSTRIES, Ltd.) are particularly preferable.

The proportion of the surfactant in the ink is not particularly limited and can be suitably selected to suit to a particular application. For example, the proportion is preferably from 0.001 to 5 percent by mass, more preferably from 0.05 to 5 percent by mass, and furthermore preferably from 0.2 to 2.0 percent by mass in terms of excellent wettability and discharging stability and improvement on image quality.

Defoaming Agent

The defoaming agent has no particular limit and examples thereof include, but are not limited to silicon-based defoaming agents, polyether-based defoaming agents, and aliphatic acid ester-based defoaming agents. These can be used alone or in combination. Of these, silicone-based defoaming agents are preferable in terms of the effect of foam breaking.

Preservatives and Fungicides

The preservatives and fungicides are not particularly limited. A specific example is 1,2-benzisothiazoline-3-one.

Corrosion Inhibitor

The corrosion inhibitor has no particular limitation. Examples are acid sulfites and sodium thiosulfates.

pH Regulator

The pH regulator has no particular limit as long as it can control pH to not lower than 7.

Specific examples include, but are not limited to, amines such as diethanol amine and triethanol amine.

Properties of the ink are not particularly limited and can be suitably selected to suit to a particular application. For example, viscosity, surface tension, and pH are preferably in the following ranges.

Viscosity of the ink at 25 degrees C. is preferably from 5 to 30 mPa·s and more preferably from 5 to 25 mPa·s because print density and text quality improve and good dischargeability is demonstrated. Viscosity can be measured by, for example, a rotatory viscometer (RE-80L, manufactured by TOKI SANGYO CO., LTD.). The measuring conditions are as follows:

Standard cone rotor (1° 34′×R24)

Sample liquid amount: 1.2 mL

Number of rotations: 50 rotations per minute (rpm)

25 degrees C.

Measuring time: three minutes.

The surface tension of the ink is preferably 35 mN/m or less and more preferably 32 mN/m or less at 25 degrees C. because the ink suitably levels on a recording medium and the drying time of the ink is shortened.

pH of the ink is preferably from 7 to 12 and more preferably from 8 to 11 in terms of prevention of corrosion of metal material in contact with liquid.

Bulk Modulus of Ink

Bulk modulus (K) of the ink can be calculated as follows:

K=ρ×v²

K: bulk modulus (Pa)

ρ: density (kg/m³)

v: speed of sound

Density and speed of sound are closely related to solid content in the ink. As the amount of the solid content increases, the density and the speed of sound increase. Bulk modulus increases as a result.

When the bulk modulus is 2.9×10⁹ Pa or greater, occurrence of satellite can be minimized. When the bulk modulus is 3.0×10⁹ Pa or less, discharging stability can be enhanced.

The proportion of the solid content in the ink is preferably from 4 to 13 percent by mass and more preferably from 5 to 12 percent by mass to control bulk modulus.

Dynamic Surface Tension of Ink

The dynamic surface tension of ink has a great impact on discharging stability, satellite, and image quality.

Ink having a dynamic surface tension of 32 mN/m or greater at 15 msec can enhance discharging stability and minimize occurrence of satellite. When the dynamic surface tension is 39 mN/m or less at 15 msec, ink widely spreads on a recording medium after the ink reaches the recording medium, which enhances image quality and image density.

The dynamic surface tension of the ink can be controlled by the type and amount of a surfactant added. The amount of a surfactant added is preferably from 0.1 to less than 2.0 percent in terms of storage stability of the ink.

Measuring of Droplet Breakage Time of Ink in Elongation Viscosity Measuring

The distance between the main droplet and the satellite of an ink droplet can be deduced by observing the elongation behavior of the ink droplet when elongation viscosity is measured by using a capillary breakage elongation viscometer and measuring the breakage time of ink droplets. As the breakage time decreases, the distance between the main droplet and the satellite in the air becomes shorter when the ink is used for printing. By contrast, as the breakage time increases, the distance between the main droplet and the satellite in the air becomes longer.

The breakage time can be controlled by increasing the dynamic surface tension of ink.

The breakage time can be controlled by changing the type and the amount of a surfactant added. It is possible to select a solvent having a high dynamic surface tension to control the breakage time by changing the amount added thereof.

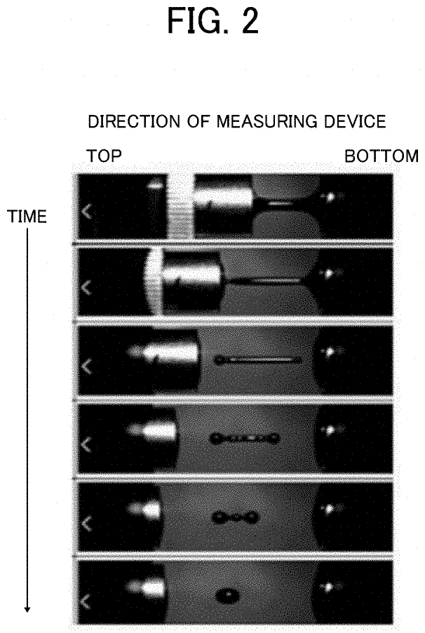

FIG. 2 is a diagram illustrating an example of measuring the breakage time in observing elongation behavior. The probe is pulled up from bottom to top to form a pillar-like liquid. Thereafter, the pillar-like liquid breaks from the top probe (breakage time) and thereafter from the bottom probe. The liquid merges from the top and the bottom in the air.

When the breakage time is 17.0 msec or less, the distance between the main drop and the satellite is short so that discharging stability is enhanced and occurrence of ink mist is reduced. Image quality is enhanced as a result. The breakage time is more preferably 14.0 msec or less.

Recording Medium

There is no specific limitation to the recording medium and it can be suitably selected to suit to a particular application. Recording media such as plain paper, gloss paper, special paper, cloth, film, transparent sheets, general printing paper are suitable.

There is no specific limit to the speed of conveying a recording medium and it can be suitably selected to suit to a particular application.

Because the ink of the present disclosure causes small satellites and reduces occurrence of mist, the ink is suitable for high performance printing. Images having high quality can be produced with the ink for printing on a recording medium conveyed at 50 m/min or more.

The amount of an organic solvent present on the image portion on a recording medium can be reduced by various drying methods.

The method of drying a recording medium is not particularly limited and can be suitably selected to suit to a particular application. The method includes heat transfer in which a heated roller directly makes contact with portions such as an image forming portion in a recording medium and a non-image forming portion such as a rear side of the image forming portion, drying by blowing heated wind to an image portion, and drying by infra red.

Of these, heat transfer by a heated roller directly making contact with an image portion in a recording medium is preferable because the heat transfer efficiency is high so that drying efficiency is excellent.

A substantive amount of organic solvent is present on the image portion immediately after the ink is applied. The image portion is preferably purged of the remaining organic solvent by heat transfer by a heated roller directly making contact with the non-image portion in the recording medium, drying by blowing heated wind to the image portion, drying by infra red without making no contact with the image portion of the recording medium, and heat transfer by a heated roller directly making contact with the image portion in the recording medium in this order. This drying minimizes the amount of the organic solvent present.

Image Forming Method and Image Forming Apparatus

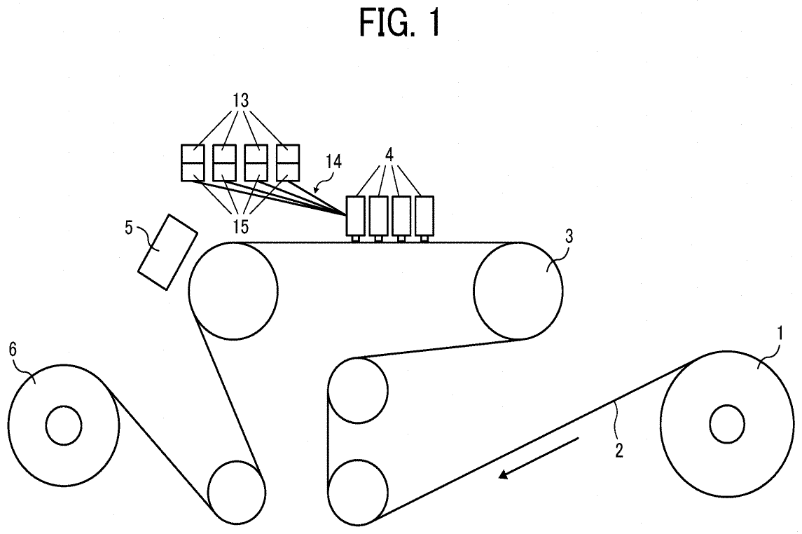

The image forming method and the image forming apparatus using the ink of the present disclosure are described with reference to FIG. 1.

As illustrated in FIG. 1, a recording medium 2 is sent out from a reeling roller 1 and conveyed to the position immediately below a discharging device 4 that discharges an ink 15 by a conveyance roller 3. The recording medium 2 to which the ink 15 has been applied by the discharging device 4 reeled up by a reeling-up roller 6 after the image is heated and dried by a heat-drying device 5.

The ink 15 is discharged from the discharging device 4 and accommodated in an accommodating unit (container) 13 such as an ink cartridge. The discharging device 4 is linked with the accommodating unit 13 via a supplying device 14 such as a tube and the ink 15 is fed from the accommodating unit 13 to the discharging device 4.

Contacting and Contacting Device

The heat-drying device 5 can be substituted with a contact device that brings a heated roller into contact with a recording medium to heat and dry the recording medium.

At the contact, the surface of the recording medium to which the ink has been applied is brought into contact with the heated roller heated to temperatures higher than room temperature.

The contact device brings the surface of the recording medium to which the ink has been applied into contact with the heated roller heated to temperatures higher than room temperature.

The contact can be suitably conducted by the contact device.

Having generally described preferred embodiments of this disclosure, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

Next, the present disclosure is described in detail with reference to Examples but is not limited thereto.

Preparation Example of Pigment Dispersion

Preparation of Black Pigment Dispersion

A total of 20 g of carbon black (FW100, manufactured by Degussa AG), 20 mmol of the compound represented by Chemical Structure 1 below, and 200 mL of deionized water were mixed by Silverson mixer (6,000 rpm) at room temperature (25 degrees C.) to obtain a slurry. The pH of the obtained slurry was lowered to 4 or less by adding 20 mmol of nitric acid. Thirty minutes later, 20 mmol of sodium nitrite dissolved in a minute amount of deionized highly pure water was slowly added to the obtained mixture. Furthermore, the temperature was raised to 60 degrees C. while the mixture was stirred to allow reaction for one hour. A reformed pigment was produced in which the compound represented by Chemical Formula 1 illustrated below was added to Pigment Blue as a result. Thereafter, by adjusting the pH to be 10 by NaOH aqueous solution, a reformed pigment dispersion was obtained 30 minutes later. The reformed pigment dispersion containing a pigment bonded with at least one geminalbis phosphonic acid group or a sodium salt of geminalbis phosphonic acid and deionized highly pure water were subject to ultrafiltering using dialysis membrane followed by ultrasonic dispersion to obtain a black pigment dispersion having a pigment solid portion of 15 percent by mass.

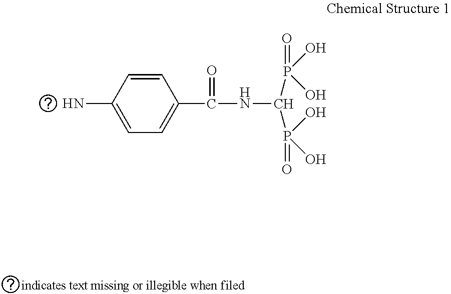 [SMILES: Nc1ccc(C(=O)NC(P(=O)(O)O)P(=O)(O)O)cc1]

### Example 1

The black pigment dispersion at 25.0 percent by mass, 1,2-propane diol at 5.0 percent by mass, 2-(2-ethoxy)ethanol at 5.0 percent by mass, glycerin at 5.0 percent by mass, BONRON™ S-1360 at 10.0 percent by mass, polyether-modified siloxane copolymer (TEGO, WET 270, manufactured by Evonik Industries AG) as a surfactant, TRITON HW-1000 at 0.5 percent by mass, a lubricant (AQUACER 593) at 1.0 percent by mass, and a deionized water at balance to make the total 100 percent by mass were mixed and stirred followed by filtering with a polypropylene filter (PROFILE® Star Filter, average pore diameter of 1.5 μm, manufactured by NIHON PALL LTD.) to prepare ink of Example 1.

### Examples 2 to 11 and Comparative Examples 1 to 3

The inks of Examples 2 to 11 and Comparative Examples 1 to 3 were prepared in the same manner as the ink of Example 1 based on the formulations shown in Table 1.

The details of the individual ingredients of the inks in Table 1 are as follows.

Organic Solvent

Dipropylene glycol dimethyhlether (Proglyde DMM, boiling point of 175 degrees C., manufactured by The Dow Chemical Company)

Dipropylene glycol monopropylether (dowanol DPnP, boiling point of 213 degrees C., manufactured by The Dow Chemical Company)
2-(2-ethoxyethoxy)ethanol (boiling point of 196 to 202 degrees C., manufactured by Tokyo Chemical Industry Co. Ltd.)
2-ethoxy ethanol (boiling point of 135 degrees C., manufactured by Tokyo Chemical Industry Co. Ltd.)
1,2-propane diol (boiling point of 188 degrees C., manufactured by Tokyo Chemical Industry Co. Ltd.)
1,3-propane diol: (boiling point of 214 degrees C., manufactured by Tokyo Chemical Industry Co. Ltd.)
1,2-butane diol: (boiling point of 194 degrees C., manufactured by Tokyo Chemical Industry Co. Ltd.)
1,3-butane diol: (boiling point of 207 degrees C., manufactured by Tokyo Chemical Industry Co. Ltd.)
3-methyl-1,3-butane diol (boiling point of 203 degrees C., manufactured by KURARAY CO., LTD.)
Glycerin (boiling point of 290 degrees C., manufactured by Sakamoto Yakuhin kogyo Co., Ltd.)

Resin Emulsion
Polyoxyethylene polyoxy propylene block copolymer (NEWPOL PE-108, manufactured by Sanyo Chemical Industries, Ltd.)
BONRON™ S-1360 (Tg>100 degrees C., manufactured by Mitsui Chemicals, Inc.)
TE-1048 (Tg=123 degrees C., manufactured by SEIKO PMC CORPORATION)

Surfactant
Polyether-modified siloxane copolymer (TEGO WET270, manufactured by Evonik Industries AG)
TRITON HW100 (manufactured by The Dow Chemical Company)
TEGO-based (manufactured by Evonik Industries AG)

Lubricant
Polyethylene wax emulsion (AQUACER 593, manufactured by BYK)

Evaluation on Ink Property

The inks obtained in Examples and Comparative Examples were subjected to elongation behavior observation to measure the droplet breakage time, bulk modulus, and dynamic surface tension These were measured at 25 degrees C.

Measuring of Droplet Breakage Time of Ink in Elongation Viscosity Measuring

The ink droplet breakage time was measured as follows.

A capillary breakage elongation viscometer (Thermo Fisher Scientific HAAKE CaBER1) and a high speed camera (Photron FASTCAM SA5) were used for the measuring. The frame rates taken from when the probe (viscometer) pulls an ink droplet to when the ink droplet is broken off from the top probe were counted to calculate the ink droplet breakage time.

Elongation Viscosity Measuring Condition

Amount of ink droplets: 0.025 g

### Initial gap: 1.0 mm

### Final gap: 14 mm

Pulling up time: 30 ms

High Speed Camera Measuring Condition

Frame rate: 7500 fps

Measuring of Bulk modulus

Bulk modulus was calculated according to the following relationship.

K=ρ×v²

K represents bulk modulus (Pa), p represents density (kg/m³), and v represents speed of sound (m/s).

Density and speed of sound were measured at 25 degrees C. using Anton Paar DSA5000M (manufactured by Anton Paar GmbH).

Measuring of Dynamic Surface Tension

The dynamic surface tension at 15 sec was measured by a portable surface tensiometer, manufactured by SITA DynoTester.

Images were formed with the inks of Examples and Comparative Examples and discharging stability, image quality, and image density of the inks were evaluated.

Image Forming Method

Roll paper (Lumi Art Gloss, weight: 130 g/m², paper width: 521 mm, manufactured by Stora Enso AB) was placed in an inkjet printing system (RICOH Pro VC 60000, manufactured by Ricoh Co., Ltd.) and a solid image having a resolution of 1200 dpi×1200 dpi was produced on the roll paper with the inks of Examples 1 to 11 and Comparative Examples 1 to 3.

The image portion on the roll paper was dried by heated wind, a heated roller having a diameter of 40 mm brought into contact with the non-image formed surface of the roll paper, and another heated roller having a diameter of 40 mm brought into contact with the image formed surface of the roll paper in this order to dry the image portion. The reeler (Rewinding module RW6, manufactured by Hunkeler AG) reeled the roll paper.

The conveyance speed of the recording medium was shown in Table 1.

Discharging Stability

Discharging stability of the ink was evaluated by the area of streaks (dot omission) appearing in the image portion after the printing system continuously printed the solid image for three hours. As the discharging stability decreases, defective discharging such as nozzle omission and deviated discharging occurs frequently, thereby increasing the area of streaks. The area of streaks was taken in by a scanner and calculated by binarization.

Scanning and image processing for binarization were performed under the following conditions.

The image was scanned by a scanner GT-X-970, manufactured by SEIKO EPSON CORPORATION in professional mode, at 300 dpi, and in color.

The image was converted into 8-bit by Image J and the transfer image area was calculated with a threshold.

Evaluation Criteria of Area Ratio of Streaks to Image Portion

S: Area ratio of dot omission was 0.0 percent

A: Area ratio of dot omission was from 0.1 to less than 0.5 percent

B: Area ratio of dot omission was from 0.5 to less than 1.0 percent

C: Area ratio of dot omission was 1.0 percent or more

Image Quality

The image quality was evaluated by using a half tone image having a filling ratio of 50 percent.

The half tone image was observed with a digital microscope. The number of dots formed by mist and the number of entire dots were visually counted to calculate the ratio of the number of dots formed by mist to the number of entire dots. Image quality is high as the number of dots formed by mist decreases.

The image quality was evaluated using the device below under the following conditions.

Measuring Device: scanning cofocal laser microscope (LEXT OLS 3100)

### Measuring Conditions

Measured image: snap shot at 20× magnification of LEXT (measured at n=3)
Image size: 0.64 mm×0.64 mm
Brightness at shooting: 25
Analysis soft: Image J (MaxEntropy) for binarization

Evaluation Criteria on Ratio of Number of Dots Formed by Mist to Number of All

### Dots

S: 0.0 percent

A: 0.1 to less than 1.0 percent

B: 1.0 to less than 5.0 percent

C: 5.0 percent or greater

Image Density Black image density of the solid image was measured by a reflection spectrum densitometer (Model: 939, manufactured by X-rite).

### Evaluation Criteria on Image Density

S: Black image density of 2.2 or greater

A: Black image density of from 2.0 to less than 2.2

B: Black image density of from 1.6 to less than 2.0

C: Black image density of less than 1.6

TABLE 1

| | Experiment | Example | | | | | | | |
|---|---|---|---|---|---|---|---|---|---|
| | No. Ink No. | 1 | 2 | 3 | 4 | 5 | 6 | 7 | 8 |
| Coloring | Black | 25.0 | 25.0 | 30.0 | 30.0 | 25.0 | 25.0 | 25.0 | 25.0 |
| material | pigment liquid | | | | | | | | |
| | dispersion | | | | | | | | |
| | (Pigment solids | | | | | | | | |
| | concentration: | | | | | | | | |
| | 15 percent by | | | | | | | | |
| | mass) | | | | | | | | |
| Organic | Dipropylene | | | | | | | | |
| solvent | glycol dimethyl | | | | | | | | |
| | ether | | | | | | | | |
| | Dipropylene | | | | | 5.0 | | | |
| | glycol mono- | | | | | | | | |
| | propyl ether | | | | | | | | |
| | 2-(2- | 5.0 | 5.0 | 5.0 | | | | | 5.0 |
| | Ethoxyethoxy) | | | | | | | | |
| | ethanol | | | | | | | | |
| | 2-Ethoxy | | | | 5.0 | | | | |
| | ethanol | | | | | | | | |
| | 1,2-Propane | 5.0 | 5.0 | 5.0 | 5.0 | 5.0 | | | 5.0 |
| | diol | | | | | | | | |
| | 1,3-Propane | | | | | | 5.0 | | |
| | diol | | | | | | | | |
| | 1,2-Butane | | | | | | 5.0 | | |
| | diol | | | | | | | | |
| | 1,3-Butane | | | | | | | 5.0 | |
| | diol | | | | | | | | |
| | 3-Methyl-1,3- | | | | | | | 5.0 | |
| | butane diol | | | | | | | | |
| | Glycerin | 5.0 | 5.0 | 5.0 | 4.0 | 4.0 | 2.0 | 4.0 | 5.0 |
| Resin | BONRON ™ | 10.0 | 2.5 | 15.0 | | | 2.0 | | 10.0 |
| emulsion | S-1360 (solid | | | | | | | | |
| | content: 44.5 | | | | | | | | |
| | percent by | | | | | | | | |
| | mass) | | | | | | | | |
| | TE-1048 | | | | | 10.0 | | 10.0 | |
| | (solid content: | | | | | | | | |
| | 31 percent) | | | | | | | | |
| | NEWPOL | | | | 6.0 | | | | |
| | PE-108 (solid | | | | | | | | |
| | content: 100 | | | | | | | | |
| | percent) | | | | | | | | |
| Surfactant | WET-270 | 0.5 | 0.1 | 0.9 | 0.1 | 0.5 | | | |
| | TRITON | 0.5 | 0.1 | 0.9 | 0.4 | 1.0 | 1.1 | 1.1 | |
| | HW-1000 | | | | | | | | |
| | TEGO ® Wet | | | | | | 1.1 | | 0.1 |
| | 500* | | | | | | | | |
| | TEGO ® Wet | | | | | | | 1.1 | |
| | 510* | | | | | | | | |
| | TEGO ® | | | | | | | | |
| | Glide 100 | | | | | | | | |
| | TEGO ® | | | | | | | | |
| | Glide 450 | | | | | | | | |
| Lubricant | AQUACER593 | 1.0 | 1.0 | 1.0 | 1.0 | 1.0 | 1.0 | 1.0 | 1.0 |
| | (solid content: | | | | | | | | |
| | 30 percent) | | | | | | | | |
| Water | Deionized | 48.0 | 56.3 | 37.2 | 48.5 | 48.5 | 57.8 | 47.8 | 48.9 |
| | water | | | | | | | | |
| Total (Percent by mass) | | 100.0 | 100.0 | 100.0 | 100.0 | 100.0 | 100.0 | 100.0 | 100.0 |
| Total solid content (percent | | 8.5 | 5.2 | 11.5 | 10.8 | 7.2 | 4.9 | 7.2 | 8.5 |
| by mass) | | | | | | | | | |
| Total amount of surfactant | | 1.0 | 0.2 | 1.8 | 0.5 | 1.5 | 2.2 | 2.2 | 0.1 |
| (percent by mass) | | | | | | | | | |
| Image | Conveyance | 50.0 | 50.0 | 50.0 | 50.0 | 50.0 | 50.0 | 50.0 | 50.0 |
| forming | speer (m/min) | | | | | | | | |
| Ink | Droplet | 12 | 14 | 15 | 4 | 16 | 17 | 16 | 10 |
| property | breakage time | | | | | | | | |
| | (msec) by | | | | | | | | |
| | elongation | | | | | | | | |
| | viscosity | | | | | | | | |
| | 15 msec | 35 | 38 | 33 | 37 | 32 | 32 | 33 | 39 |
| | dynamic | | | | | | | | |
| | surface tension | | | | | | | | |
| | (mN/m) | | | | | | | | |
| | Bulk modulus | 2.95 | 2.93 | 2.99 | 2.98 | 2.91 | 2.91 | 2.94 | 2.97 |
| | (10⁹ Pa) | | | | | | | | |
| Evaluation | Dot omission | 0.0 | 0.0 | 0.9 | 0.3 | 0.2 | 0.4 | 0.5 | 0.1 |
| | area ratio | | | | | | | | |
| | (percent) | | | | | | | | |
| | Discharging | S | S | B | A | A | A | A | A |
| | stability | | | | | | | | |
| | Dot ratio | 0.0 | 0.5 | 0.6 | 0.0 | 3.5 | 3.9 | 4.0 | 0.0 |
| | (percent) | | | | | | | | |
| | Image quality | S | A | A | S | B | B | B | S |
| | Image density | 2.2 | 1.6 | 2.3 | 1.9 | 2.1 | 2.5 | 2.5 | 0.6 |
| | Image density | S | B | S | B | A | S | S | B |
| | (evaluation) | | | | | | | | |

| | | | | | Comparative | | |
|---|---|---|---|---|---|---|---|
| | Experiment | Example | | | Example | | |
| | No. Ink No. | 9 | 10 | 11 | 1 | 2 | 3 |
| Coloring | Black | 25.0 | 30.0 | 25.0 | 25.0 | 25.0 | 25.0 |
| material | pigment liquid | | | | | | |
| | dispersion | | | | | | |
| | (Pigment solids | | | | | | |
| | concentration: | | | | | | |
| | 15 percent by | | | | | | |
| | mass) | | | | | | |
| Organic | Dipropylene | 5.0 | | | | | |
| solvent | glycol dimethyl | | | | | | |
| | ether | | | | | | |
| | Dipropylene | | | | | | |
| | glycol mono- | | | | | | |
| | propyl ether | | | | | | |
| | 2-(2- | | 5.0 | 5.0 | 5.0 | 5.0 | 5.0 |
| | Ethoxyethoxy) | | | | | | |
| | ethanol | | | | | | |
| | 2-Ethoxy | | | | | | |
| | ethanol | | | | | | |
| | 1,2-Propane | 5.0 | | 5.0 | 5.0 | 5.0 | 5.0 |
| | diol | | | | | | |
| | 1,3-Propane | | | | | | |
| | diol | | | | | | |
| | 1,2-Butane | | | | | | |
| | diol | | | | | | |
| | 1,3-Butane | | | | | | |
| | diol | | | | | | |
| | 3-Methyl-1,3- | | 5.0 | | | | |
| | butane diol | | | | | | |
| | Glycerin | 5.0 | 1.0 | 5.0 | 5.0 | 5.0 | 5.0 |
| Resin | BONRON ™ | | | 10.0 | | | |
| emulsion | S-1360 (solid | | | | | | |
| | content: 44.5 | | | | | | |
| | percent by | | | | | | |
| | mass) | | | | | | |
| | TE-1048 | | 10.0 | | | | |
| | (solid content: | | | | | | |
| | 31 percent) | | | | | | |
| | NEWPOL | 0.8 | 5.0 | | | | 0.5 |
| | PE-108 (solid | | | | | | |
| | content: 100 | | | | | | |
| | percent) | | | | | | |
| Surfactant | WET-270 | | | 0.5 | 3.0 | | |
| | TRTTON | 0.5 | | 0.5 | 1.0 | | |
| | HW-1000 | | | | | | |
| | TEGO ® Wet | | 1.0 | | | | 1.0 |
| | 500* | | | | | | |
| | TEGO ® Wet | | | | | | |
| | 510* | | | | | | |
| | TEGO ® | 0.5 | | | | | 1.0 |
| | Glide 100 | | | | | | |
| | TEGO ® | 0.5 | | | | | |
| | Glide 450 | | | | | | |
| Lubricant | AQUACER593 | 1.0 | 1.0 | 1.0 | 1.0 | 1.0 | 1.0 |
| | (solid content: | | | | | | |
| | 30 percent) | | | | | | |
| Water | Deionized | 56.7 | 42.0 | 48.0 | 55.0 | 59.0 | 56.5 |
| | water | | | | | | |
| Total (Percent by mass) | | 100.0 | 100.0 | 100.0 | 100.0 | 100.0 | 100.0 |
| Total solid content (percent | | 4.9 | 12.9 | 8.5 | 4.1 | 4.1 | 4.6 |
| by mass) | | | | | | | |
| Total amount of surfactant | | 1.5 | 1.0 | 1.0 | 4.0 | 0.0 | 2.0 |
| (percent by mass) | | | | | | | |
| Image | Conveyance | 50.0 | 50.0 | 100.0 | 50.0 | 100.0 | 50.0 |
| forming | speer (m/min) | | | | | | |
| Ink | Droplet | 15 | 8 | 12 | 20 | 18 | 18 |
| property | breakage time | | | | | | |
| | (msec) by | | | | | | |
| | elongation | | | | | | |
| | viscosity | | | | | | |
| | 15 msec | 34 | 35 | 35 | 30 | 40 | 40 |
| | dynamic | | | | | | |
| | surface tension | | | | | | |
| | (mN/m) | | | | | | |
| | Bulk modulus | 2.92 | 2.98 | 2.95 | 2.88 | 2.85 | 2.89 |
| | (10⁹ Pa) | | | | | | |
| Evaluation | Dot omission | 0.1 | 0.8 | 0.0 | 1.5 | 0.3 | 0.5 |
| | area ratio | | | | | | |
| | (percent) | | | | | | |
| | Discharging | A | B | S | C | A | B |
| | stability | | | | | | |
| | Dot ratio | 4.2 | 0.0 | 0.5 | 6.0 | 8.0 | 5.2 |
| | (percent) | | | | | | |
| | Image quality | B | S | A | C | C | C |
| | Image density | 2.2 | 2 | 2 | 2 | 1.3 | 1.6 |
| | Image density | A | A | A | A | C | A |
| | (evaluation) | | | | | | |

The present disclosure relates to the ink of the following 1 and also includes the following 2 to 10 as embodiments.

1. An ink contains an organic solvent and a coloring material, wherein the ink has a droplet breakage time of 17.0 msec or less according to elongation viscosity measuring.

2. The ink according to 1 mentioned above, wherein the ink has a bulk modulus of 2.9×10⁹ Pa or more.

3. The ink according to 2 mentioned above, wherein the ink has a bulk modulus of 3.0×10⁹ Pa or less.

4. The ink according to any one of 1 to 3 mentioned above, wherein the ink has a dynamic surface tension of 32 mN/m or more at 15 msec.

5. The ink according to 4 mentioned above, wherein the ink has a dynamic surface tension of 39 mN/m or less at 15 msec.

6. The ink according to any one of 1 to 5 mentioned above, further contains a surfactant.

7. The ink according to 6 mentioned above, wherein the proportion of the surfactant in the ink is from 0.2 to 2.0 percent by mass.

8. The ink according to any one of 1 to 7 mentioned above, wherein the proportion of solid content in the ink is from 5 to 12 percent by mass.

9. An image forming method includes discharging the ink of any one of 1 to 8 mentioned above to a recording medium conveyed at 50 m/min or greater.

10. An image forming apparatus includes a conveyance device configured to convey a recording medium at 50 m/min or greater, the ink of any one of 1 to 8 mentioned above and a discharging device configured to discharge the ink.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

What is claimed is:

1. An ink comprising:
an organic solvent; and
a coloring material,
wherein the ink has a droplet breakage time of 17.0 msec or less according to elongation viscosity measuring.

2. The ink according to claim 1, wherein the ink has a bulk modulus of 2.9×10⁹ Pa or more.

3. The ink according to claim 2, wherein the ink has a bulk modulus of 3.0×10⁹ Pa or less.

4. The ink according to claim 1, wherein the ink has a dynamic surface tension of 32 mN/m or more at 15 msec.

5. The ink according to claim 4, wherein the ink has a dynamic surface tension of 39 mN/m or less at 15 msec.

6. The ink according to claim 1, further comprising a surfactant.

7. The ink according to claim 6, wherein a proportion of the surfactant in the ink is from 0.2 to 2.0 percent by mass.

8. The ink according to claim 1, wherein a proportion of solid content in the ink is from 5 to 12 percent by mass.

9. An image forming method comprising:
discharging the ink of claim 1 to a recording medium conveyed at 50 m/min or more.

10. An image forming apparatus comprising:
a conveyance device configured to convey a recording medium at 50 m/min or more;
the ink of claim 1;
a container that contains the ink; and
a discharging device configured to discharge the ink.
